(19) United States
(12) Patent Application Publication
(10) Pub. No.: US 2007/0174877 A1
(43) Pub. Date: Jul. 26, 2007

(54) Device and method for automatically obtaining information relating to the audiences of programs transmitted by a communication network

(75) Inventors: Serge Papillon, Paris (FR); Sylvain Squedin, Bondoufle (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/516,575

(22) Filed: Sep. 7, 2006

(30) Foreign Application Priority Data
Sep. 9, 2005 (FR) 0552730

(51) Int. Cl. H04N 7/16; H04N 7/173; H04J 1/00

(52) U.S. Cl. 725/86; 370/486; 725/62; 725/100; 725/131; 725/139; 725/98

(57) ABSTRACT

A device (DA) is dedicated to analyzing data relating to access to programs (or contents) that are transmitted by communication networks (R) to communication terminals (T1-T3) that are attached to them. The device (DA) comprises a memory (B) and processor means (MT) adapted i) on receiving a first message transmitted by a terminal (T1) that has just accessed a program including at least first data representative of that program, to store the first data in the memory (B) in corresponding relationship to second data representative of the time access to the program began and third data representative of the terminal (T1) that accessed said program, ii) on receiving a second message transmitted by a terminal (T1) that has just ceased to access a program including at least the first data representative of that program, to store the first data in the memory (B) in corresponding relationship to fourth data representative of the time at which access to said program ceased and third data representative of the terminal (T1) that has ceased to access said program, and iii) to access at least some of the data stored in the memory (B) to determine at least information representative of the audiences of at least some of the programs.

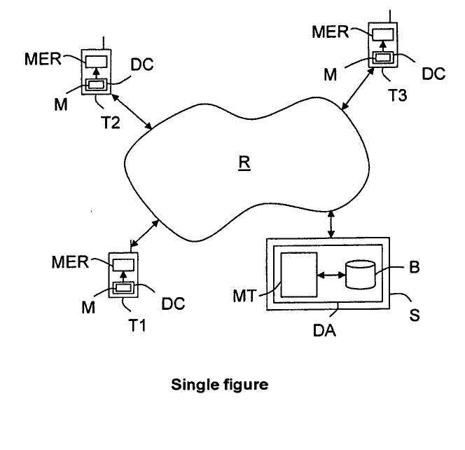

The invention relates to mobile or fixed communication networks in which programs (or contents), for example television, music, radio, multimedia or video programs (or contents) are transmitted to communication terminals, and more precisely to obtaining information relating to access by the terminals to those programs (or contents).

Because of the strong competition between program (or content) broadcasters, it is particularly important for them to have as much information as possible relating to the audiences achieved by their various programs (or contents).

At present there are two main methods for estimating program (or content) audiences.

The first method is entirely oral. It consists in interviewing a sample of persons in the street or by telephone. It is not practicable for this method to be used in real time. Also, it is costly because it requires staff to conduct the interviews and to prepare reports. Moreover, the number of persons interviewed being limited, the error rate for audience results is high.

The second method is automated. It consists in connecting the televisions of a sample of persons deemed to be representative of a selected portion of a population to analysis units that continuously record the identifier of the television program that is being watched in order to transmit it to a remote equipment together with complementary information such as the time spent watching programs and the times at which access to programs begins and ends. Each person in the household has his own remote controller and is identified in terms of a market segment (child, man, woman, etc.).

This second method is purely qualitative rather than quantitative. Moreover, it entails the permanent connection of a unit to a program receiver and is therefore not at all suitable for mobile communication terminals, such as mobile (or cellular) telephones, laptop computers and personal digital assistants (PDA), for example. It is also costly because it necessitates the connection of a unit to each television covered by the analysis. Moreover, the number of persons covered by the analysis being limited, the error rate in respect of the audience results is again high, and may be even higher if a number of the analysis units fail.

No solution known in the art proving entirely satisfactory, an object of the invention is therefore to improve upon this situation.

To this end the invention proposes a method dedicated to determining data relating to access to programs (or contents) that are transmitted by at least one communication network to communication terminals that are attached to it.

The method is characterized in that it consists in:

causing each terminal that accesses a program to transmit to an analyzer device a first message including at least first data representative of the program accessed,

storing the first data in the analyzer device in corresponding relationship to second data from the first message that is representative of the access time and third data representative of the terminal that accessed the program,

causing each terminal that ceases to access a program to transmit to the analyzer device a second message including at least the first data representative of the program,

storing the first data from the second message in the analyzer device in corresponding relationship to fourth data representative of the time at which access to the program ended and third data representative of the terminal that has ceased to access the program, and

analyzing at least some of the data stored in the analyzer device to determine at least information representative of the audiences of at least some of the programs.

The method of the invention may have other features, and in particular, separately or in combination:
the analysis may be effected in real time;
characteristics (or profiles) of the users of the terminals may be determined and at least some of the stored data may then be analyzed as a function of at least some of the user characteristics;
   at least some of the user characteristics may be determined from third data representative of their terminals;
   the terminals may add to the first and/or second messages fifth data representative of at least some of the user characteristics;
the first messages may contain the second data;
the second messages may contain the fourth data;
if it is impossible to transmit a first or second message after it is generated, the message may be stored in the terminal that generated it in order to transmit it offline;
the first and second messages may be transmitted in a secure manner.

The invention also proposes a device for analyzing data relating to access to programs (or contents) that are transmitted by at least one communication network to communication terminals that are attached to it.

The device is characterized in that it comprises storage means and processor means adapted:

on receiving a first message transmitted by a terminal that has just accessed a program including at least first data representative of the program that has been accessed, to store the first data in the storage means in corresponding relationship to second data representative of the time access to the program began and third data representative of the terminal that accessed the program,

on receiving a second message transmitted by a terminal that has just ceased to access a program including at least the first data representative of the program, to store the first data in the storage means in corresponding relationship to fourth data representative of the time at which access to the program ceased and third data representative of the terminal that has ceased to access the program, and

to access at least some of the data stored in the storage means to determine at least information representative of the audiences of at least some of the programs.

The analyzer device of the invention may have other features and in particular, separately or in combination:

its processor means may be adapted to effect at least some of the determinations in real time;

its processor means may be adapted to determine the second data on receiving a first message and/or the fourth data on receiving a second message;

its processor means may be adapted to determine characteristics of the users of the terminals and to effect at least some of the determinations on the basis of at least some of the data and as a function of at least some of the characteristics so determined;

its processor means may be adapted to determine at least some of the characteristics of the users of the terminals from third data representative of their terminals stored in the storage means;

its processor means may be adapted to extract from the first and/or second messages fifth data representative of at least some of the characteristics of the users of the terminals.

The invention further proposes a control device for a communication terminal attached to a communication network adapted to transmit programs (or contents), comprising control means adapted, on the one hand, in the event of access of the terminal to a program, to generate a first message to be sent to an analyzer device of the above kind including at least first data representative of the program that has been accessed, and, on the other hand, in the event of the terminal ceasing to access the program, to generate a second message to be sent to the analyzer device including at least the first data representative of the program.

The control device of the invention may have other features and in particular, separately or in combination:

its control means may be adapted to add to the first messages second data representative of the time at which the program was accessed;

its control means may be adapted to add to the second messages fourth data representative of the time at which access to the program ended;

its control means may be adapted, if it is impossible to transmit a first or second message after it is generated, to store the message in order to transmit it offline;

its control means may be adapted to add to the first and/or second messages fifth data representative of characteristics of the user of the terminal;

its control means may be adapted to instruct their terminal to transmit the first and second messages in a secure manner.

The invention is particularly well adapted, although not exclusively so, to mobile (or cellular) communication networks and to fixed communication networks including high bit rate data transmission lines, for example xDSL (x Digital Subscriber Line) type lines, cables or optical fibers. Generally speaking, the invention relates to any communication network having a virtually permanent return channel (as in some satellite networks providing Internet access).

Other features and advantages of the invention will become apparent on reading the following detailed description and examining the appended drawing, the single figure whereof is a diagram of a portion of a mobile communication network to which are connected mobile communication terminals equipped with one embodiment of a control device of the invention and a server equipped with one embodiment of an analyzer device of the invention. The appended drawing constitutes part of the description of the invention as well as contributing to the definition of the invention, if necessary.

The object of the invention is to produce information relating to the audiences achieved by programs (or contents) of any type automatically, in real time and without recourse to an external unit.

This invention applies to any fixed or mobile type of communication terminal provided that it can be connected to a fixed communication network (preferably including high bit rate data transmission lines, for example xDSL (x Digital Subscriber Line) type lines, cables or optical fibers) or a mobile communication network (preferably of the UMTS type or variants and equivalents thereof), where applicable via a modem (modulator/demodulator). For example, the terminal could be a mobile (or cellular) telephone, a personal digital assistant (PDA), an encrypted television program decoder, a set-top box type television program receiver unit or a fixed or portable computer.

As indicated above, the invention relates to any type of communication terminal that can be connected to a communication network having a virtually permanent return channel (for example a satellite network providing Internet access).

It is considered hereinafter by way of nonlimiting example that the communication terminals (referred to hereinafter as “terminals”) are UMTS type mobile telephones that can be connected to a mobile (or cellular) communication network to receive by radio music programs and/or television programs and/or video programs, for example in accordance with a DVB-H (Digital Video Broadcasting-Handset) type standard.

As shown in the single figure, the invention necessitates equipping terminals Ti (possibly all such terminals) with a control device DC and installing an analyzer device DA in a communication equipment S, for example a server, connected to a communication network that is not necessarily the mobile network R to which said terminals are connected.

It is important to note that the only constraint in relation to the communication equipment S in which the analyzer device DA of the invention is installed is that it must be connected to a communication network accessible to fixed or mobile communication terminals via their parent network(s). Consequently, it can be connected to a private network, a mobile network or the Internet provided that the parent network(s) of the terminals are coupled directly or indirectly to the network to which it is connected.

Furthermore, the network to which the communication equipment S in which the analyzer device DA of the invention is installed is connected, being connectable to networks of different types (for example mobile networks, cable networks and xDSL networks), the analyzer device DA can be adapted to process data from terminals of different types (for example mobile telephones and television receivers connected to xDSL lines or optical fibers).

It is considered hereinafter by way of nonlimiting example that the server S is connected to the mobile network R that is the parent network of the terminals Ti and receives data only from said terminals Ti (which here are mobile telephones).

Moreover, in the present example there are three terminals T1 to T3 (i=1 to 3), but the number of terminals Ti can be as high as may be required (it suffices to equip the required number of terminals Ti with a control device DC).

A control device DC of the invention comprises a control module MC that intervenes each time the terminal Ti in which it is installed begins to access a program (or content) and ceases to access that program (or content).

For example, the control module MC may be informed that access to a program has begun or ended by the display module MA, using specific events or messages to which another program can subscribe. In either case, a message sender module must be provided in the display module MA or in an external module. A message sender module of this kind may offer a “zapping” (fast inter-program navigation) filter function, preferably one that is configurable. Thus when a first or second message is generated, it may be stored for a selected (configurable) time before it is sent. For example, if the stored message is a beginning of access message and an end of access message is generated before the end of the selected storage time, the action is deemed to constitute zapping and both messages are destroyed without being sent.

Alternatively, the control module MC may observe the operation of the display module MA in order to detect each time that access to a program begins and ends. It may also use the above zapping detection function.

More precisely, each time that its terminal Ti accesses a program, the control module MC generates a first message including at least first data representative of the program accessed, for example its identifier or the identifier of the channel on which it is transmitted. It then communicates this first message to the sender/receiver module MER of its terminal Ti in order for it to transmit it to the analyzer device DA (in fact to the server S in which the device is installed).

Various exchange media may be used to transmit the first and second messages. For example, a signaling channel may be used if the analyzer device DA is in the network of the user's access provider. If not, an IP (Internet Protocol) channel may be used, for example.

Similarly, each time that its terminal Ti ceases to access a program, the control module MC generates a second message including at least the first data representative of that program. It then communicates this second message to the sender/receiver module MER of its terminal Ti in order for it to transmit it to the analyzer device DA (in fact to the server S in which the device is installed).

Any technique may be used to distinguish a first message from a second message. One illustrative and nonlimiting example of this is for the control module MC to append to these messages a type field containing a 0 bit or a 1 bit, for example. It assigns the value 0 to the type field of a first message and the value 1 to the type field of a second message, for example.

It is important to note that the control module MC may instruct its terminal Ti to transmit the first and second messages in a secure manner.

When the server receives a first or second message it forwards it to the analyzer device DA.

As shown diagrammatically in the figure, the analyzer device DA comprises storage means B and a processor module MT.

The storage means B store data received from the processor module MT and may take any form, for example a memory or a database (the latter is the option discussed hereinafter).

Each time that the processor module MT receives a first message from a terminal Ti that has just begun to access a program, it extracts from the message the first data that is representative of the program and then determines second data representative of the time at which the program is accessed and third data representative of the terminal Ti accessing the program.

The time necessary for a first message to travel between a control device DC and an analyzer device DA being very short, especially given the time accuracy required for audience measurements, and the time taken by a control module MC to generate a first message following detection of access to a program by a terminal Ti also being very short, the processor module MT may take the time of receiving the first message as the time at which access to the program begins, for example. Consequently, the second data may be considered to be representative of the time at which the first message is received. Alternatively, the processor module MT may subtract from the time at which a first message is received a constant value representative of the travel time and the time necessary to generate the first message.

Another option that may be envisaged is for each control module MC to add second data representative of the time at which its terminal Ti begins to access a program. In this case, when the processor module MT receives a first message, it no longer needs to determine the time at which access to the program begins, since that time is represented by the second data that the message contains.

As indicated above, any technique may be used to distinguish between a first message and a second message. One illustrative and nonlimiting example of this is for the second data to be accompanied by a bit whose value indicates the beginning of access (as opposed to the ending of access). For example, the value of this bit may be fixed by the value of the type field contained in the first message (for example the value 0 for beginning access and the value 1 for ending access).

One nonlimiting example of this is for the third data to take the form of the communication identifier of the terminal Ti that is accessing the program (or content), i.e. the terminal that has just transmitted a first message. Again by way of nonlimiting example, the communication identifier may be the telephone number in the case of a mobile telephone or the electronic mail (e-mail) address in the case of a computer or a television receiver connected to a cable network. Generally speaking, any data may be used that uniquely identifies the user of a service.

The processor module MT stores the first data from each first message received in corresponding relationship to the second and third data, for example in a multiplet.

Each time that the processor module MT receives a second message from a terminal Ti that has just ceased to access a program it extracts from the message the first data that is representative of the program and then determines fourth data representative of the time at which access to the program ended and third data representative of the terminal Ti that was previously accessing the program.

As indicated above, the time necessary for a second message to travel between a control device DC and an analyzer device DA being very short, especially given the time accuracy required for audience measurements, and the time taken by a control module MC to generate a second message after the detection of its terminal Ti ceasing to access a program also being very short, the processor module MT may take the time of receiving the second message as the time access to the program ended, for example. Consequently, the fourth data may be considered to be representative of the time of receiving the second message. Alternatively, the processor module MT may subtract from the time of receiving a second message a constant value representative of the travel time and the time necessary to generate the second message.

Another option that may be envisaged is for each control module MC to add fourth data representative of the time at which its terminal Ti ceases to access a program. In this case, when the processor module MT receives a second message, it no longer needs to determine the time at which access to the program ended since that time is represented by the fourth data that the message contains.

As indicated above, any technique may be used to distinguish between a first message and a second message. An illustrative and nonlimiting example of this is for the fourth data to be accompanied by a bit whose value indicates access beginning (as opposed to access ending). For example, the value of this bit may be fixed by the value of the type field contained in the second message (for example the value 1 for ending access and the value 0 for beginning access).

The processor module MT stores the first data from each second message received in corresponding relationship to the third and fourth data, for example in a multiplet.

The processor module MT also accesses on request at least some of the data stored in the database B (first data (program identifier), second data (time of beginning access to program), third data (terminal Ti identifier) and fourth data (time of ending access to program)) in order to determine at least information representative of the audiences of at least some of the programs to which that data relates.

A few schematic audience data analysis examples are given hereinafter by way of illustration only.

The audience for a program may be defined, for example, as the number of persons who watch the program for a selected time, for example the whole of its duration or a selected percentage of its duration, for example more than 90% of its duration.

To determine the audience for a program, the processor module MT may therefore begin by extracting from the database B all the multiplets that contain the same first data representative of the program. It may then determine which of the extracted multiplets contain third data representative of the some terminal identifier Ti. It may then determine the duration of access by each terminal Ti to the program from the second and fourth data in multiplets containing the same third data. Finally, it may compare each duration determined in this way to a threshold in order to retain the terminals Ti that are associated with a duration above said threshold, for example. The number of these terminals fixes the audience for the program concerned.

The processor module MT may also be adapted to analyze the data stored in its database B with the aim of determining other information representative of the audiences for at least some of the programs, for example average times and/or average time bands at/in which access begins and/or average time bands in which access ends and/or audience figures.

For example, to determine the audience figures for a set of programs transmitted during intersecting time intervals, the processor module MT may first determine the audience for each of the programs of the set in the manner described above. It then sums those audiences and divides the audience for each program of the set by the sum of the audiences, which gives the required audience figure.

To determine the average program access time, the processor module MT can start by extracting from the database B all the multiplets that include the same first data representative of the program, for example. It then determines which of the extracted multiplets include third data representative of the same terminal identifier Ti. It then determines the time at which each terminal Ti began to access the program from the second and fourth data from the multiplets having the same third data. Finally, it sums the durations that it has determined and divides that sum by the number of terminals that accessed the program concerned, which fixes the average program access time.

To determine the average time band in which access a program begins, the processor module MT may begin by extracting from the database B all the multiplets that contain the same first data representative of the program and second data representative of the program access times, for example. It may then “sum” the access times and divide that sum by the number of terminals that accessed the program concerned, which fixes the average time at which access to the program began.

To determine the average time band at which access to a program ended, the processor module MT may begin by extracting from the database B all the multiplets that contain the same first data representative of the program and fourth data representative of the time access to the program ended, for example. It may then “sum” the times at which access ended and divide that sum by the number of terminals that accessed the program concerned, which fixes the average time at which access to the program ended.

The ways of processing audience data described above merely constitute schematic examples that are not limiting on the invention. Many statistical models for processing audience data are known in the art. As a general rule, the audience data obtained by means of the invention may be stored and subjected afterwards to any appropriate statistical (or other) processing that may be required. It is important to note that “live” results (for example the number of persons watching a given program at the time), and even live or offline results correlated with user characteristics (for example the number of 15-25 year olds watching a given program), can then be made available to the clients of the analyzer device DA.

Many types of user characteristic (or at least portions of user profiles) may be useful to program broadcasters, in particular to refine traffic analyses or audience ratings, for example the age range and/or areas of interest and/or types of broadcast preferred and/or sex, etc.

The processor module MT can obtain these user characteristics in various ways. One way is for the processor module MT to determine selected characteristics (or at least portions of user profiles) of the users of the terminals Ti from the third data stored in the database B that represents their terminals Ti.

To this end, the processor module MT can send requests for transmission of selected user characteristics (identified by the identifiers of their terminals Ti) to the parent networks of the terminals Ti that send it first and second messages. Accordingly, when the processor module MT has access to those selected features, it may determine at least some of the audience results on the basis of at least some of the data stored in the database B and as a function of at least some of the characteristics that have been determined in this way.

Another way to proceed, and one that is not mutually exclusive with the previous one, is to have the terminals Ti transmit (fifth) data representative of characteristics of their users, which may be added to the other data stored in the database B and accessible to the processor module MT. In this case, the control device DC installed in a terminal Ti can add (fifth) data to the first and/or second messages, for example. The processing module MT can then use that (fifth) data, and where applicable other data, to effect certain of its analyses. The transmission of some or all of these user characteristics by the terminals Ti may depend on local legislation and/or on the users agreeing to it beforehand.

The result of an analysis effected by the processor module MT takes the form of final data that is delivered by its analyzer device DA in the form of a message.

It has been assumed hereinabove that the terminals Ti are in a position to transmit their first and second messages live. This is not always possible, however, in particular if the network (GPRS) is not available at the time of generating a message, although the program broadcasting network is operating. To take account of these situations, the control module MC of a control device DC installed in a terminal Ti may be adapted to store an unsent message in a dedicated memory, for example, in order to transmit it subsequently (as soon as possible).

The control device DC of the invention, and in particular its control module MC, and/or the analyzer device DA, and in particular its processor module MT and its storage means B, may take the form of electronic circuits, software (or electronic data processing) modules, or a combination of circuits and software.

If the control device DC is implemented entirely in software, it can either be installed in a terminal during the fabrication or commissioning thereof or downloaded into a terminal via its parent network or from another type of terminal (for example a personal computer (PC)) via interterminal communication means (for example of Bluetooth type).

The invention is particularly advantageous in that it offers a method of determining quantitative audience data and possibly qualitative audience data, if necessary.

The invention is not limited to the control device, communication terminal, analyzer device and data determination method embodiments described hereinabove by way of example only and encompasses all variants that the person skilled in the art might envisage that fall within the scope of the following claims.

1. Method of determining data relating to access to programs that are transmitted by at least one communication network (R) to communication terminals (Ti) that are attached to it, characterized in that it consists in i) causing each terminal (Ti) that accesses a program to transmit to an analyzer device (DA) a first message including at least first data representative of the program accessed, ii) storing in said analyzer device (DA) said first data in corresponding relationship to second data from the first message that is representative of the access time and third data representative of the terminal (Ti) that accessed the program, iii) causing each terminal (Ti) that ceases to access a program to transmit to said analyzer device (DA) a second message including at least the first data representative of said program, iv) storing said first data from the second in said analyzer device (DA) message in corresponding relationship to fourth data representative of the time at which access ended and third data representative of the terminal (Ti) that has ceased to access the program, and v) analyzing at least some of said data stored in said analyzer device (DA) to determine at least information representative of the audiences of at least some of said programs.

2. Method according to claim 1, characterized in that said analysis is effected in real time.

3. Method according to claim 1, characterized in that characteristics of the users of said terminals (Ti) are determined and at least some of the stored data is then analyzed as a function of at least some of said user characteristics.

4. Method according to claim 3, characterized in that at least some of said user characteristics are determined from third data representative of their terminals.

5. Method according to claim 3, characterized in that said terminals add to said first and/or second messages fifth data representative of at least some of said user characteristics.

6. Method according to claim 4, characterized in that said terminals add to said first and/or second messages fifth data representative of at least some of said user characteristics.

7. Method according to claim 1, characterized in that said first messages contain said second data.

8. Method according to claim 4, characterized in that said first messages contain said second data.

9. Method according to claim 1, characterized in that said second messages contain said fourth data.

10. Method according to claim 4, characterized in that said second messages contain said fourth data.

11. Method according to claim 1, characterized in that, if it is impossible to transmit a first or second message after it is generated, said message is stored in the terminal that generated it in order to transmit it offline.

12. Method according to claim 4, characterized in that, if it is impossible to transmit a first or second message after it is generated, said message is stored in the terminal that generated it in order to transmit it offline.

13. Method according to claim 1, characterized in that said first and second messages are transmitted in a secure manner.

14. Method according to claim 4, characterized in that said first and second messages are transmitted in a secure manner.

15. Device (DA) for analyzing data relating to access to programs that are transmitted by at least one communication network (R) to communication terminals (Ti) that are attached to it, characterized in that it comprises storage means (B) and processor means (MT) adapted i) on receiving a first message transmitted by a terminal (Ti) that has just accessed a program including at least first data representative of the program that has been accessed, to store in said storage means (B) said first data in corresponding relationship to second data representative of the time access to said program began and third data representative of the terminal (Ti) that accessed said program, ii) on receiving a second message transmitted by a terminal (Ti) that has just ceased to access a program including at least the first data representative of said program, to store in said storage means (B) said first data in corresponding relationship to fourth data representative of the time at which access to said program ceased and third data representative of the terminal (Ti) that has ceased to access said program, and iii) to access at least some of the data stored in said storage means (B) to determine at least information representative of the audiences of at least some of said programs.

16. Device according to claim 15, characterized in that said processor means (MT) are adapted to effect at least some of said determinations in real time.

17. Device according to claim 15, characterized in that said processor means (MT) are adapted to determine said second data on receiving a first message and/or said fourth data on receiving a second message.

18. Device according to claim 15, characterized in that said processor means (MT) are adapted to determine characteristics of the users of said terminals (Ti) and to effect at least some of said determinations on the basis of at least some of said data and as a function of at least some of said user characteristics.

19. Device according to claim 17, characterized in that said processor means (MT) are adapted to determine at least some of the characteristics of the users of said terminals (Ti) from third data representative of their terminals (Ti) stored in said storage means (B).

20. Device according to claim 17, characterized in that said processor means (MT) are adapted to extract from said first and/or second messages fifth data representative of at least some of the characteristics of the users of said terminal (Ti).

21. Control device (DC) for a communication terminal (Ti) attached to a communication network (R) adapted to transmit programs, characterized in that it comprises control means (MC) adapted, i) in the event of access of said terminal (Ti) to a program, to generate a first message to be sent to an analyzer device (DA) according to claim 15 including at least first data representative of the program that has been accessed, and ii) in the event of said terminal (Ti) ceasing to access said program, to generate a second message to be sent to said analyzer device (DA) including at least said first data representative of said program.

22. Control device (DC) for a communication terminal (Ti) attached to a communication network (R) adapted to transmit programs, characterized in that it comprises control means (MC) adapted, i) in the event of access of said terminal (Ti) to a program, to generate a first message to be sent to an analyzer device (DA) according to claim 17 including at least first data representative of the program that has been accessed, and ii) in the event of said terminal (Ti) ceasing to access said program, to generate a second message to be sent to said analyzer device (DA) including at least said first data representative of said program.

23. Device according to claim 20, characterized in that said control means (MC) are adapted to add to said first messages second data representative of the time at which the program was accessed.

24. Device according to claim 20, characterized in that said control means (MC) are adapted to add to said second messages fourth data representative of the time at which access to the program ended.

25. Device according to claim 20, characterized in that said control means (MC) are adapted to add to said first and/or second messages fifth data representative of characteristics of the user of the terminal (Ti).

26. Device according to claim 20, characterized in that said control means (MC) are adapted, if it is impossible to transmit a first or second message after it is generated, to store said message in order to transmit it offline.

27. Device according to claim 20, characterized in that said control means (MC) are adapted to instruct their terminal (Ti) to transmit said first and second messages in a secure manner.
